(19) United States
(12) Patent Application Publication
(10) Pub. No.: US 2016/0243818 A1
(43) Pub. Date: Aug. 25, 2016

(54) FILTER SYSTEM FOR A PRINTING MACHINE

(71) Applicant: Kraft-Schloetels GmbH, Wassenberg (DE)

(72) Inventors: Ralph DITTMANN, Essen (DE); Dirk MOERS, Wassenberg (DE)

(21) Appl. No.: 14/628,352

(22) Filed: Feb. 23, 2015

(51) Int. Cl. B41F 31/02

(52) U.S. Cl. CPC B41F 31/02

(57) ABSTRACT

The invention relates to a filter system for a printing machine, comprising a filter basin (1) into which the process water of a printing machine is fed, wherein the filter basin (1) is subdivided vertically into an upper water inlet zone (2) and a lower water outlet zone (3) that are separated by a fleece filter web (5) supported by a water-permeable, continuous conveyor belt (4), the fleece filter web (5) displaced on the conveyor belt (4) by a drive from a fleece filter supply (6) through the filter basin (1) to a collecting zone (8) and force is applied to the fleece filter web (5) toward the conveyor belt (4) by the weight of the process water bearing against the fleece filter web (5), and the process water passes through the fleece filter web (5) solely by the static pressure of the process water bearing against the fleece filter web (5), and the conveyor belt (5) is driven as a function of the process-water depth. The invention also relates to a method of operating a filter system for a printing machine.

The invention relates to a filter system for a printing machine. The invention further relates to a method of operating a filter system for a printing machine. It is known from the prior art that printing machines, particularly web presses, are operated with a process water, frequently also called “wet water,” where the process water is subject to contamination during operation of the printing machine, for example by particulate dirt, mainly from paper and ink, but also oils, mainly from ink.

In order to be able to recycle the process water, the prior art provides for feeding the process water through a filter system of a printing machine, purifying the water particularly through multiple filtration, and recycling it to the printing machine where it is again contaminated during operation.

The common method entails feeding contaminated process water generated in the printing machine particularly to a plurality of filters and/or filter bags by pumps and, under actively generated pressure, passing it through the filters that get clogged by the retained particulate or also liquid contaminants and that must be replaced at regular intervals of sometimes only a few hours. In case of insufficient filter performance, the process water is fed to additional purifying steps. This includes the use of purification systems with further filters or also purification systems that operate with centrifugal force. However, operation of such purification systems is very elaborate and cost-intensive, and throughput is very low.

The prior art requires that replaceable filter units be available at the operating site of the printing machine filter system and replacing the filters by maintenance personnel. The previous method is further disadvantageous because there is no filtration taking place during replacement of the filter material and the process water is not filtered during such time. The previous method is further disadvantageous because the filter effect constantly changes due to contamination of the filter and the process water is thus continuously changing properties. The previous method is further disadvantageous because the dirt contained in the process water and possibly also air bubbles are finely dispersed due to the active pumping of the process water from a printing machine to the printing machine filter system and are consequently more difficult to remove in the printing machine filter system.

In view of the above, the object of invention is to provide a filter system for a printing machine as well as a method of operating such a filter system, by means of which a greater filtration effectiveness is achieved, less maintenance personnel is required, a constant filter effect and constant process water quality is achieved, maintenance intervals are preferably extended, and filter quantities and waste are reduced.

This object is attained by a filter system for a printing machine, comprising a filter basin into which the process water of a printing machine is fed, wherein the filter basin is subdivided vertically into an upper water inlet zone and a lower water outlet zone, wherein the two zones are separated by a fleece filter web supported by a water-permeable, continuous conveyor belt, the fleece filter web being motor-driven on the conveyor belt from a fleece filter supply, particularly a supply roll, through the filter basin to a collecting zone, and the fleece filter web is biased against the conveyor belt by the weight of the process water bearing against the fleece filter web, and the process water passes through the fleece filter web solely by the static pressure of the process water bearing against the fleece filter web, and the conveyor belt is powered as a function of the process-water depth in the inlet zone.

With a method of operating a filter system for a printing machine, particularly of the above-described type, the problem is further solved by feeding the process water of a printing machine to a filter basin, in which force is applied to a fleece filter web by the weight of the process water, whereby the fleece filter web is pressed onto the surface of a conveyor belt continuously operated in the filter basin, and the open-loop or feedback-type controlled movement of the conveyor belt, depending on the process-water depth, is carried along by frictional traction.

An essential central idea of the invention is that of automatically taking a fleece filter web from a supply, particularly from a supply roll, guiding it through the filter basin where the fleece filter web performs its filter function, and, in case of contamination, also automatically moving it out to a collecting zone. According to the invention, the fleece filter web separates the upper water inlet zone from the lower water outlet zone, and therefore, except for any flow out of an emergency overflow, the process water that flows into the filter basin must necessarily pass through the fleece filter web.

Contrary to previous measures in the prior art, according to which pressure was actively applied to the process water by pumps, the system as well as the method do not actively generate pressure in the filter system for filtering the process water; instead, the process water is pushed through the fleece filter web exclusively by the static pressure of the process water bearing against the fleece filter web, the pressure being passively generated by the weight of the water. The filter basin, its inlets and outlets, and the active filter surface in the filter basin are preferably dimensioned such that all the process water accumulating per time unit can be filtered, particularly without using the filter system on part of the water and bypassing the rest. The process water bearing against the fleece filter web presses the soaked fleece filter web by the weight of the process water column against the conveyor belt arranged below the fleece filter web, thus generating a frictional traction connection between the lower face of the fleece filter web and the upper face of the conveyor belt that, in case of a motorized transport of the conveyor belt in a predetermined direction, causes the fleece filter web to be conveyed along in the same direction. Therefore, no mechanical intervening means are required between conveyor belt and fleece filter web, which mechanically simplifies the filter system.

The fleece filter web is preferably guided longitudinally into the filter basin over an upper edge of the filter basin, the edge being formed, for example by a deflection roller. Then, the fleece filter web is guided through the filter basin, along the upper face of the conveyor belt, and guided out on the opposite side over an upper edge that, in turn, can be formed by a deflection roller. Therefore, the process water surrounds the fleece filter web between the edges.

In order to prevent water from flowing unfiltered past the longitudinal sides of the fleece filter web, it is possible to seal this side zone between the fleece filter web and the filter basin, for example by a support element impermeable to water, particularly a strip-type support element that, following the upper face of the conveyor belt, protrudes from the side wall of the filter basin into the filter basin and supports a lateral edge of the fleece filter web. This support element can be arranged between the upper face of the conveyor belt and the lower face of the fleece filter web.

The invention further provides for the conveyor belt to be displaced as a function of the process-water depth above the fleece filter web which, for example, can be done by a controller with or without feedback.

This is based on the consideration that, with advancing clogging of the fleece filter web by the dirt carried along by the process water, increasing resistance is generated during passage through the fleece filter web, which cause the process water column to increase.

According to the invention, this rise, or generally, the process-water depth, is detected, and the conveyor belt is powered as a function of the detection, for example if a predetermined process-water depth is exceeded, the drive of the conveyor belt is controlled, preferably in order to further transport the conveyor belt by a predetermined distance, and so a portion of the contaminated fleece filter web is moved out of the filter basin and a portion of fresh uncontaminated fleece filter web is moved into the filter basin, thus reducing the process-water depth once more. A feedback-type control, for example can be provided for the process-water depth to alternate between a minimum depth value and a maximum depth value.

In this manner, a particularly favorable deep filtration as well as greater freedom from maintenance or distinctly extended maintenance intervals, when compared to the prior art, can be achieved with such a fleece filter web because, depending on the process-water depth, the fleece filter web is advanced in the filter basin until the supply, particularly the supply roll, is depleted, and only then is a new supply roll to be used in the filter system according to the invention.

In particular, the process water in the filter basin is also calmed because filtration is effected exclusively by the static pressure of the water column bearing against the fleece filter web, and so particulate or liquid contaminates in the process water are comminuted no further as would be the case with dynamic pressurization or use of pumps.

In a preferred development of the invention, the printing machine filter system can be below the level of the process water outlet of a printing machine, and the process water is fed from the printing machine to the filter basin by a process water supply line solely by gravity.

When compared to the prior art, pumps are thus eliminated for moving the process water from a printing machine to the filter system, and therefore there is no further comminution of dirt in the transport path.

In particular, the dispersion of dirt and/or air in the process water, as described disadvantageously with regard to the prior art and that is caused by the action of a pump impeller, can be completely avoided according to the invention.

In order to further contribute to a calming of the process water when entering the filter system, the invention can also provide for a process water supply line from the printing machine to open into the inlet zone of the filter basin below the level of the process water in the filter basin. Thus, any surface movements of the process water and other introduction of air caused by the water flow in the inlet zone can be prevented or at least reduced to, once again, increase filtration effectiveness.

The invention can further provide, depending on the required process water volume flow rate, that the cross-sectional size of the process water supply line is dimensioned such that, due to the predetermined flow rate, the required volume flow rate is such that there are no dirt deposits from the process water in the process water supply lines; instead, the dirt is kept safely in suspension and moved to the filter basin. For example, a minimum flow rate of 1 meter per second can be provided.

Furthermore, the cross section can be further dimensioned such that a maximum flow rate to be observed of, for example 2 m/sec, is not exceeded in order to ensure that no unnecessary turbulence is generated to contribute to a comminution or dispersion of dirt particles and/or air or liquid dirt components. This way, an optimal process water transport is ensured in a preferred flow rate interval between the above-mentioned values.

Regardless of the above-mentioned two aspects, but particularly in combination herewith, according to the invention the flow cross section of the mouth of the process water supply line at the point of the inlet zone is enlarged relative to the flow cross section of the process water supply line upstream therefrom in the flow direction.

For example, such an enlargement can be constituted at least by a factor of 2, for example by splitting a line into two or more lines of the same cross section as the upstream single line.

The invention can specifically provide for the cross section of the process water supply line to have such an enlargement no more than half a meter upstream of where it opens into the water inlet zone.

This also reduces turbulence of the process water in the inlet zone because, due to the enlargement of the cross section and at the predetermined volume flow, the flow rate of the process water at the mouth is reduced. This ensures particularly that dirt accumulations already deposited on the fleece filter web are not swirled up again by the incoming process water.

In particular, the water flow of the contaminated process water flowing into the inlet zone below the process water surface in the filter basin is deflected in upward, i.e. away from the fleece filter web, by a guide, such as one or more guide plates.

In a development, the process water supply line has a vent in a zone upstream of where it opens into the water inlet zone.

This ensures that air bubbles carried along in the process water supply line are prevented from entering the water inlet zone of the filter basin because they leave the process water at the vent before getting to the water inlet zone.

For example, such a vent can be a standpipe on the process water supply line upstream of the zone where the supply line opens into the inlet zone, particularly between 0-50 cm upstream of the opening into the inlet zone, the standpipe being vented upward, particularly open to the surroundings. The upper end of such a vented, particularly open standpipe is preferably above the maximum reachable process water level in the inlet zone of the filter basin, so a water leak from the standpipe is safely prevented at all times.

As initially described, it is an essential aspect of the invention that the process-water depth in the inlet zone of the filter basin never exceeds a maximum depth, particularly alternates between a minimum and a maximum depth, or is particularly adjusted. To attain this object, the invention preferably provides for contact-free measuring of the depth of the process water with a sensor above the process water level.

The contact-free measuring particularly ensures that the sensor used does contact the process water and is thus not subject to contamination by the process water; the sensor used thus being particularly substantially maintenance-free so it can operate with constant values. Adherence of dirt on the sensor that, according to the invention, can be prevented, would otherwise alter the measuring behavior.

In a possible application, the process water depth or a measurement representing such depth can be determined with an ultrasonic sensor that determines the duration of an ultrasonic pulse between sending and receiving, where, between sending and receiving, the ultrasonic pulse is reflected on the process-water surface in the inlet zone.

It is also possible to provide an optical light barrier, for example with a design, with which a light signal is reflected on the water surface and received by a sensor, particularly at an angle greater than zero relative to the surface normal of the water surface.

In a particularly preferred design of the invention, the process-water depth is determined, particularly controlled as a function of the measurements of an air-pressure sensor on the upper end of an upwardly closed pipe that has its lower open end below the water surface of the process water in the inlet zone, and so an air column is enclosed between the lower end and the sensor arranged at the upper end.

In case of a rising process water level in the inlet zone, the water level will thus also rise in the closed pipe and compress the air column located above the water level in the pipe, causing an increase of air pressure in the upper zone of the pipe that is, according to the invention, correspondingly detected by the air-pressure sensor.

If the measured air pressure exceeds a predetermined threshold value in this design, the conveyor belt is driven as a function of the threshold value, for example shifted by a predetermined amount or changed with regard to a travel speed, and so the fleece filter web is partially replaced and the water level falls accordingly.

The invention can also provide for the drive of the conveyor belt to be set as a function of the above-described measurement of the air-pressure sensor but also as a function of any other measurement device for determining the process water level, i.e. the conveyor belt is stepped intermittently by a predetermined travel distance between standstill and forward movement.

However, the invention can also provide for the conveyor belt is moved continuously at a predetermined normal speed and, starting at this normal speed, the speed is reduced in the event that a decrease of the process water level below a predetermined minimum level is detected by a sensor for example of the above-described type, or the speed is increased in the event that the process water level rises above a predetermined maximum level is detected. This ensures continuous operation of the conveyor belt and contributes to a reduction of wear.

The invention can further also provides for an additive, particularly a chemically or physically acting additive, to be added to the process water that causes dirt particles to agglomerate to particle clusters in the process water. As a result, the agglomerated particle clusters that have a greater cross section than the particles, are easier to filter out with the fleece filter web used.

For example, an additive can be used that bond with chalk or kaolin particles. For example, the invention can provide for the type of the additive used or the amount of an additive used to be selected as a function of the size of the filter pores of the fleece filter web used.

Since process water in a printing machine is kept at a certain temperature, particularly at a lower temperature than the ambient temperature at the operating site of a printing machine, the invention can further provide for a thermal insulation of the filter system against the surroundings for the purpose of reducing a temperature increase in the filter system.

For example, walls of the filter basin that delimit the process water from the surroundings can be provided with an insulation material or designed so as to be double-walled with the gap between the walls evacuated or filled with an insulation material.

In general, a development of the invention also provides for a scale in the collecting zone of the fleece filter web that is moved from the filter basin and saturated with dirt, for determining the weight of the contaminated fleece filter web.

For example, based on the determined weight, particularly the basis weight of the contaminated fleece filter web or the weight per running meter at a predetermined fleece filter web width, conclusions can be drawn about the amount of the bonded dirt, according to which operating parameters of the filter system, for example the depth of the process water level to be monitored and/or the normal speed of the fleece filter web, are changed. In addition, conclusions about the filtration process and the behavior of the materials used (paper, ink, etc.) are possible.

In a possible further development, the contaminated fleece filter web, particularly prior to being fed to the collecting zone, can be drained, thus reducing the waste to be disposed and loss of process water. For example, the fleece filter web can be drained by guiding it between two rollers that squeeze the process water from the fleece filter web and return it to the inlet zone.

The invention also provides for a measuring of the fleece filter web consumption or detection of the end of the fleece filter web supply. For example, the unrolling from a supply roll can be detected by a pulse generator and signaled after a predetermined pulse rate is exceeded, preferably before the actual end of the roll is reached.

According to a development, the return of the process water can be measured by a flow meter.

Furthermore, it is also possible to analyze multiple measured data and thus draw conclusions about the printing process. For example, hereto, measured data about the following indicators are possible individually or in combination:
Fleece advance (or consumption) per hour
Fleece advance (or consumption) per volume flow process water
Weight of contaminated fleece filter web per hour
Weight of contaminated fleece filter web per volume flow process water
Weight of contaminated fleece filter web per fleece advance (or consumption)

Provided that the materials used in the printing machine, such as paper, ink, moistening agent, etc., are recorded in addition to the measurements derived according to the invention, very revealing indicators can be determined for evaluating the qualities of the input materials. For example, the following indicators must be named:
Washout behavior paper (quality paper)
Washout behavior ink (quality ink)
Filter behavior filter fleece (quality fleece filter material)
Effectiveness moistening agent (quality moistening agent)

In the following, an embodiment of a printing machine filter system is described. The design and/or operational mode described in the following can be combined with all designs of the above-described general description.

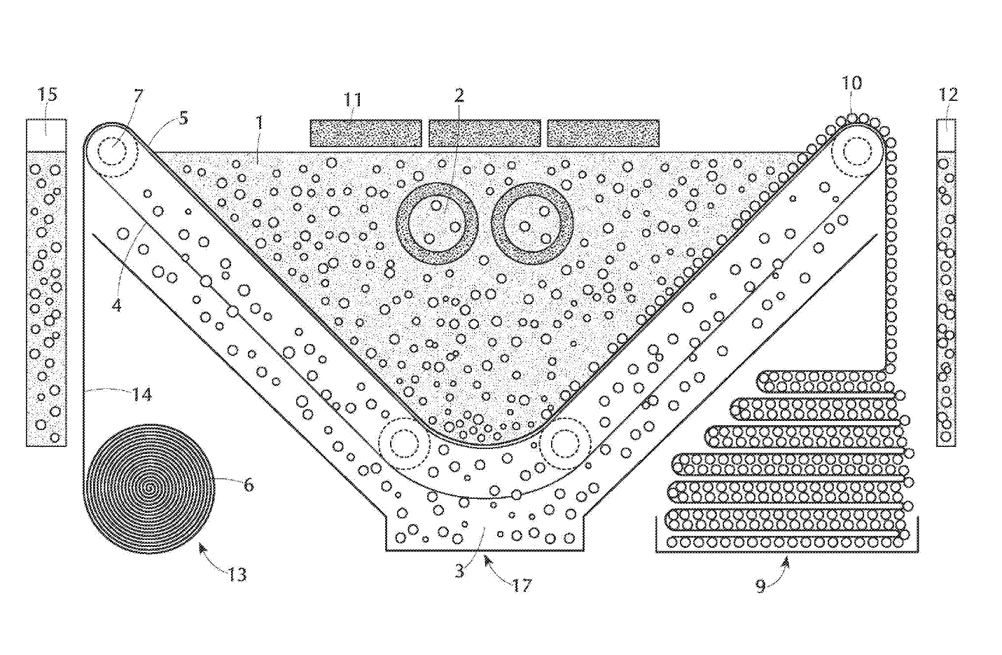

FIG. 1 is an overall view of a filter basin 1 according to the invention that, in the illustrated cross section, has outer walls arranged in a V-shape that, for example, extend between unillustrated vertical walls that are parallel to the view plane.

It can be seen that a closed conveyor belt 4 is motor-driven over deflection rollers 7 along the V-forming walls that extend relative to one another at an angle of, for example 90°. The conveyor belt hangs free the two upper deflection rollers, thus forming a concave dish permeable to the process water.

The face of the water-permeable conveyor belt, particularly its upper face that, aside from the lower reversing zone, is substantially parallel to the V-forming walls, carries a fleece filter web 5 pulled from a supply roll 6 over a deflecting roller 7 at the upper edge of the left filter basin wall and into the filter basin, and guided out of the filter basin over the upper face of the right filter basin wall 10, over a conveyor belt deflection roller, and toward a collecting zone 8.

Since the process water must flow through the fleece filter web, apart from a possible emergency overflow 11, from a water inlet 2 that opens above to a water outlet 3 that here is below, the process water bears vertically against the fleece filter web and passes through the fleece filter web by hydrostatic pressure, thus reaching the water outlet 3 in order to be returned to the process water cycle.

A sensor 12 monitors the process water level in the inlet zone and a motorized drive 7 of the continuous conveyor belt is driven as a function of the detected depth. In this case, the sensor 12 is arranged on the upper closed end of a pipe whose lower open end is submerged in the process water. The sensor measures the air pressure of the air column in the pipe above the process water that increases with the increasing process-water depth.

Since the fleece filter web is pressed against the surface of the water-permeable conveyor belt by the weight of the water bearing against it, traction and/or friction is generated between the lower face of the fleece filter web and the upper face of the conveyor belt, and as a result the fleece filter web aligns itself exactly to the shape of the conveyor belt that is concave relative to the water, and is carried along with the conveyor belt on movement of the conveyor belt without requiring further mechanical intervening means between the fleece filter web and the conveyor belt.

A scale 9 that, for example is arranged below the collecting zone 8, determines the weight of the collected fleece filter web and for example uses it for controlling or signaling purposes.

1. A filter system for a printing machine having a filter basin into which the process water of the printing machine is fed, wherein
the filter basin is vertically subdivided into an upper water inlet zone and a lower water outlet zone,
the two zones are separated by a fleece filter web supported by a water-permeable and continuous conveyor belt,
the fleece filter web is moved by a drive from a fleece filter supply through the filter basin to a collecting zone by the conveyor belt such that force is applied to the fleece filter web toward the conveyor belt by the weight of the process water bearing against the fleece filter web and the process water passes through the fleece filter web solely by the static pressure of the process water column bearing against the fleece filter web, and
the conveyor belt is moved as a function of the process-water depth.

2. The filter system for a printing machine according to claim 1, wherein the filter system is below a level of the process water outlet of the printing machine, and the process water from the printing machine is fed to the filter basin by a process water supply line solely by gravity.

3. The filter system for a printing machine according to claim 1, wherein a process water supply line from a printing machine opens into the water inlet zone of the filter basin below a level of the process water.

4. The filter system for a printing machine according to claim 3, wherein a flow cross section of the mouth of the process water supply line where it opens into the inlet zone is enlarged at least by a factor of 2 relative to a flow cross section of the process water supply line upstream therefrom.

5. The filter system for a printing machine according to claim 3, wherein the process water supply line has a vent upstream of where the supply line opens into the inlet zone and is formed by an upwardly open standpipe arranged upstream of where the supply line opens into the inlet zone so air is released from the process water at the vent such that the process water is fed at least substantially without air to the inlet zone.

6. The filter system for a printing machine according to claim 1, wherein a process-water depth is determined as a function of measurements of a sensor out of contact with the process water in that an air-pressure sensor arranged on the upper end of a pipe that is closed on top and arranged with its lower open end below the water surface of the process water in the inlet zone.

7. A method of operating a filter system for a printing machine wherein the process water of a printing machine is fed to a filter basin solely by gravity such that force is applied to a fleece filter web by the weight of the process water, thus pressing the fleece filter web onto the surface of a conveyor belt continuously operated in the filter basin and carried along by traction of frictional engagement by the movement of the conveyor belt, controlled with or without feedback as a function of the process water level above the fleece filter web.

8. The method according to claim 7, wherein a measurement representing the depth of the process water is measured without contact by a sensor above the process water surface.

9. The filter system according to claim 1, further comprising:
means for adding an additive to the process water that causes an agglomeration of the particles into particle clusters that can be filtered out with the fleece filter web used and would not be filtered out without additive.

10. A filter system for a printing machine through which process water is circulated, the system comprising:
a filter basin having an inlet and an outlet below the inlet;
a supply line between the printing machine and the inlet for conducting the process water from the printing machine to the inlet;
a return line between the printing machine and the outlet for returning the process water from the basin to the printing machine;
a closed water-permeable conveyor belt having an upwardly concave upper stretch extending through the basin between the inlet and the outlet and displaceable in a travel direction through the basin, whereby the upper stretch defines in the basin an upper inlet zone including the inlet and a lower outlet zone including the outlet;
a supply of an elongated fleece filter web;
guides for feeding the filter web onto an upstream end of the upper stretch of the belt and off a downstream end of the upper stretch of the belt such that the filter web lies atop the upper stretch and hydrostatic pressure of the process water in the inlet zone presses the web down onto the upper stretch; and
drive means for advancing the upper stretch of the belt and the web lying thereon in the travel direction such that the web advances through the basin.

11. The filter system defined in claim 10, further comprising:
a sensor for determining a depth of the process water in the inlet zone above the upper stretch of the belt;
control means connected between the sensor and the drive means for varying a travel speed of the belt and web in the travel direction according to the determined depth by increasing the travel speed on a depth increase and decreasing the travel speed on a depth decrease.
